(19) United States
(12) Patent Application Publication
(10) Pub. No.: US 2016/0167305 A1
(43) Pub. Date: Jun. 16, 2016

(54) SYSTEM AND METHOD FOR SERVING CONTENT DURING A 3D PRINTING PROCESS

(71) Applicant: Chae J. Pak, Portland, OR (US)

(72) Inventor: Chae J. Pak, Portland, OR (US)

(21) Appl. No.: 14/566,662

(22) Filed: Dec. 10, 2014

(51) Int. Cl. B29C 67/00; G06F 17/50; G05B 15/02

(52) U.S. Cl. CPC B29C 67/0088; G05B 15/02; G06F 17/50; B33Y 50/02

(57) ABSTRACT

The present application provides a standalone digital rights manager coupled with a transaction manager that serves content to a user printing a 3D Model on an at-home printer. The method provided by the present application manages the transaction between the Creator/Publisher of the 3D Model, content Provider and the user that prints the 3D Model. The method allows tracking and traceability with control for number of prints made to the quantity of relevant content presented. This is either natively configured, from 1 to infinite at compilation of the archive using the stand alone digital rights manager or controlled by the content Provider Service available on the Internet during print time.

### CROSS-REFERENCE

The present application claims priority to Provisional Patent Application Ser. No. 61/916,163, filed Dec. 14, 2013, the disclosures of which are hereby incorporated herein by reference.

### TECHNICAL FIELD

The present invention relates to the 3D Printing, and more specifically to serving proprietary content on the screen of a user printing a 3D Model.

### BACKGROUND

As 3D Printing for individual consumers becomes more pervasive due to cheaper, more powerful and application-plentiful 3D Printers, the demand for 3D Models is bound to grow. The Publishers or Creators of the files needed for printing a 3D Model may monetize their creation by means of providing certain proprietary content such as content alongside the 3D Model files, as opposed to selling a single use copy of the 3D Model file.

Hence, there exists a need for methods and systems that provide Publishers of Computer-aided Designs and 3D Models another channel to monetize their creation; that will accelerate the amount of useful products for 3D Printing at home that is cost affordable as well as offer products and parts no longer in mass production or reasonably available. The system and method needs to provide the Publishers an alternative method to the direct payment model and accelerate the growth of the At-Home 3D Printing market.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an embodiment, a system for presenting content while a 3D Model prints is provided. The system provides control of the 3D Model so that the content being presented can reliably be transacted upon for example, recorded and controlled fir various purposes. The system comprises of a Cloud Server configured for serving the content. The content may be dynamic in nature i.e. requiring an Internet connection or native in the archive such as pre-loaded content and does not require an Internet connection. The system also comprises a user device having a web browser and a Plugin installed. The content may be presented in the web browser and the content may be media such as images, audio and/or video. The system also comprises of a publisher device having a locally-adjustable digital counter and archiving system in the form of a software development kit (SDK). Such a kit may be stand alone or work with one or more applications such as Autocad, Solidworks, Blender, and the like through an application programming interface available on the Internet.

The present application provides a standalone digital rights manager coupled with a transaction manager that serves content to a user printing a 3D Model on an at-home printer. The method provided by the present application manages the transaction between the Creator/Publisher of the 3D Model, content Provider and the user that prints the 3D Model. The method allows tracking and traceability with control for number of prints made to the quantity of relevant content presented. This is either natively configured, from 1 to infinite at compilation of the archive using the standalone digital rights manager or controlled by the content Provider Service available on the Internet during print time.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present invention, reference is now made to the following descriptions taken in conjunction with the accompanying drawing, in which:

FIG. 1 illustrates a flowchart describing the Preparation of the 3D Model file including the interaction between a publisher device and a Cloud Server for both models.

FIG. 2 illustrates a flowchart describing the Printing Process using the .ads file, according to a first embodiment.

FIG. 3 illustrates a flowchart describing the Printing Process using the .ads file, according to a second embodiment.

FIG. 4 illustrates a flowchart describing the Printing Process using encrypted 3D Model file, according to a first embodiment.

FIG. 5 illustrates a flowchart describing the Printing Process using encrypted 3D Model file, according to a second embodiment.

FIG. 6 illustrates a flowchart describing the end-to-end creation and delivery of the 3D Model and content including the interaction between the Publisher and the Cloud Server and User and Cloud Server.

FIG. 7 illustrates a block diagram describing the publisher device, user device, Cloud Server, and the flow of process.

FIG. 8 illustrates a block diagram describing the .ads file or model file and its content.

FIG. 9 illustrates a block diagram describing the encrypted 3D Model and its contents after compilation.

FIG. 10 illustrates a block diagram describing the Application Programming Interface and print phases availability.

### DETAILED DESCRIPTION OF THE FIGURES

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

As used in this application, the terms “component/module” and “system” and the like are intended to refer to a computer-related entity, either hardware, a combination of hardware and software, software, or software in execution. For example, a component/module may be, but is not limited to being, a process running on a processor, a processor, an object, an instance, an executable, a thread of execution, a program, and/or a computer. By way of illustration, both an application running on a computer and the computer can be a component. One or more components/modules may reside within a process and/or thread of execution and a component/module may be localized on one computer and/or distributed between two or more computers.

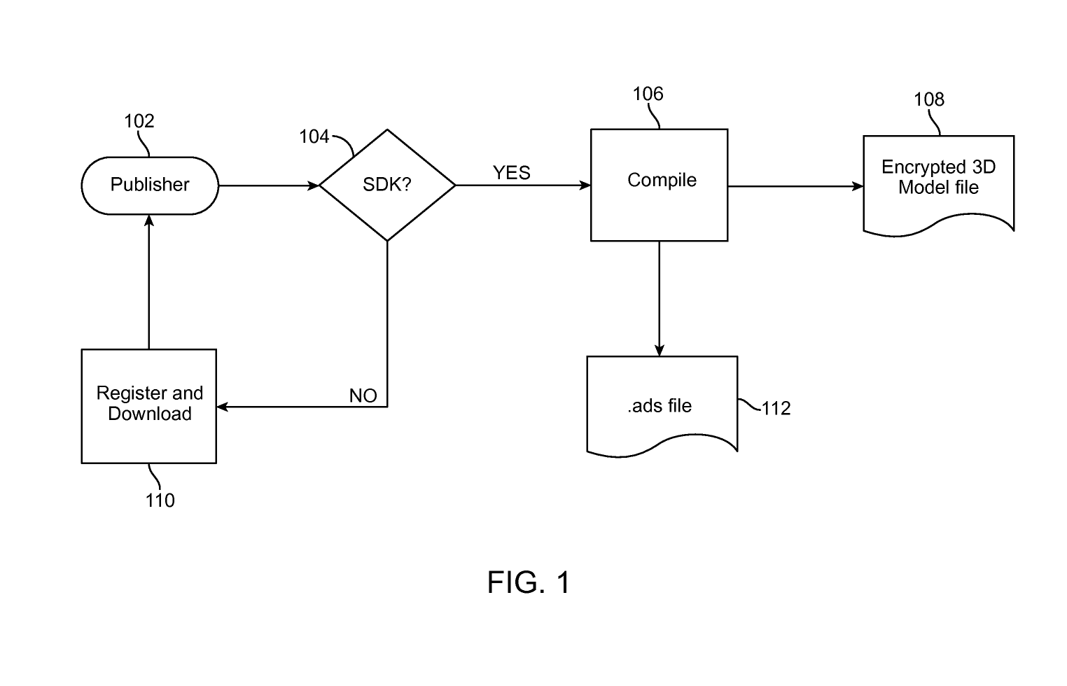

FIG. 1 illustrates a flowchart describing the Preparation of the 3D Model file including the interaction between a publisher device and a Cloud Server for both models. The Publisher of a 3D Model has access to the publisher device (102) having a software development kit (104) installed. In case, the Publisher does not have the software development kit, he is required to register and download (110) software development kit (104). The Publisher by means of the software development kit (104) is enabled to create CAD files related to creation of the 3D Model and is also enabled to link any proprietary content that may be displayed or played to a user who prints the 3D Model. When the Publisher compiles (106) the file, this will produce two different binaries firstly, an encrypted 3D Model file (108) that contains the original CAD file with encryption and embedded content including a custom error message; secondly, a .ads file (112), which has the original CAD with all files to print. A user may utilize either the .ads file or the original recompiled CAD file for printing the 3D Model.

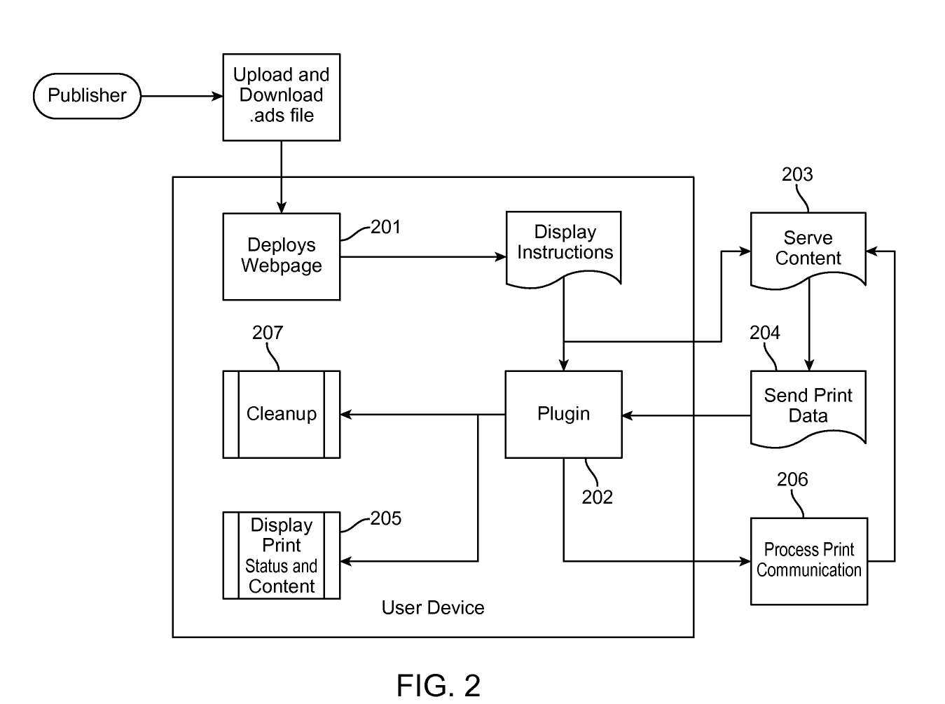

FIG. 2 illustrates a flowchart describing the Printing Process using the .ads file, according to a first embodiment. The Publisher may upload a .ads file on a website or by means of any other available medium may provide the .ads file to the user for download. At step (201), the user may access a WebPage by means of a web browser installed on a user device. The WebPage may include instructions for downloading files including a link for Plugin updates or necessary patches required for printing such as a print driver. The user device may connect to the Internet for accessing the WebPage, but required for downloading the files, and the like. The user device also has at least one processor for processing the instructions and an output device such as a display unit for facilitating the content to be presented. The user device upon downloading the relevant files, if any, utilizes a Plugin (202) for fetching the information for printing the 3D Model as well as for fetching the content stored in a Cloud Server. Environmental information of the user device along with user preferences by means of the Plugin may be sent to a Cloud Server (203) for fetching the appropriately selected content as well as additional instructions for 3D Printing. At step (204), the information is fetched by the Plugin and the 3D Model starts to be printed by means of a 3D Printer at the user end and the content is presented at the user device. The printing process is continuously monitored by means of a process print communication (206) module, this helps in presenting appropriate proprietary content during the whole process of printing the 3D Model. In effect, the Plugin manages the printing process as well as the presentation of content. Moreover, an error message might be provided in case there is an error with the printing process.

Prior to printing, the content will be matched with the 3D Model file size and estimated complexity to print. Additionally, during printing, content may use user activity to determine the quantity, type and category of content to be served. Everything in between will be determined by tracking user engagement with the printing process, history, network and market conditions, and the like. The web browser and Plugin are required as well as must be open and running respectively during print time, so that the decryption of 3D Model and serving of the content could be managed.

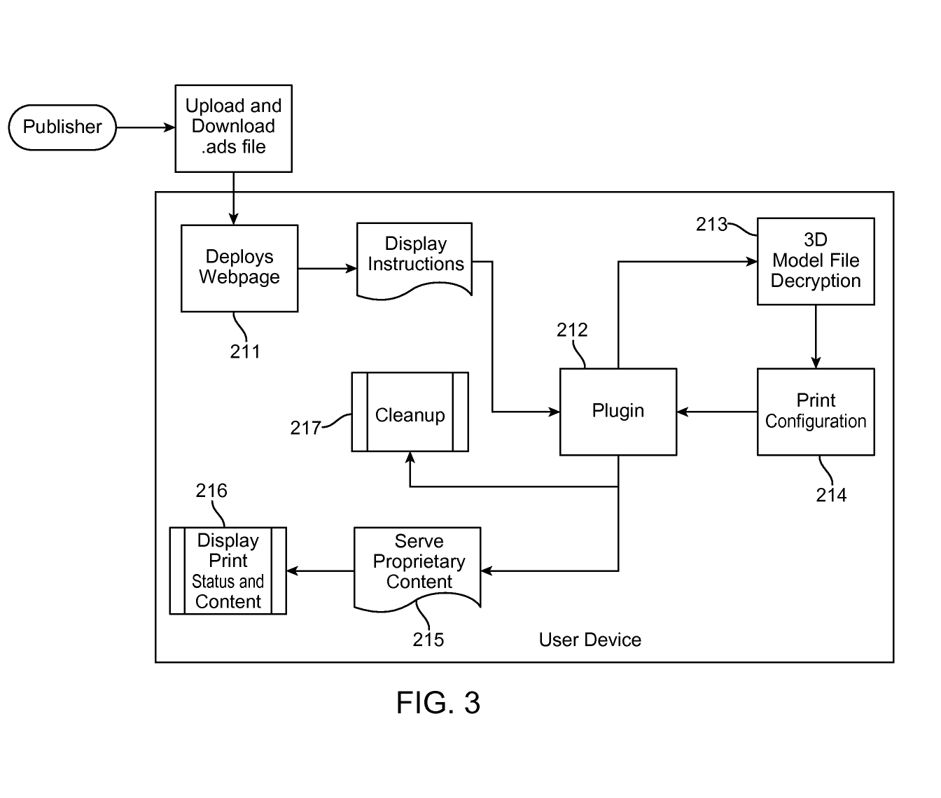

FIG. 3 illustrates a flowchart describing the Printing Process using the .ads file, according to a second embodiment. FIG. 3 describes an embodiment wherein the content is pre-fetched along with the .ads file. The content may be nested within one or more files downloaded along with the .ads file. Such pre-fetched content is added during compile time itself. In the present embodiment, the Plugin need not require additional information to be made available during the printing process. The Plugin continuously monitors the printing process and for synchronizing the presentation of the content on the user device and the printing of the 3D Model by the 3D Printer. The Plugin at step (213) decrypts the 3D Model related files and then at step (214) configures the printing of the 3D Model. At step (215), the Plugin serves the embedded content to the user device for presentation at the presentation unit. In any aspect, the content along with a printing status may be presented at the user device. In effect, the Plugin manages the printing process as well as the presentation of content. The web browser and Plugin are required as well as must be open and running respectively during print time, so that the decryption of 3D Model and serving of the content could be managed. Moreover, an error message might be embedded in the .ads files that are presented in case there is an error with the printing process.

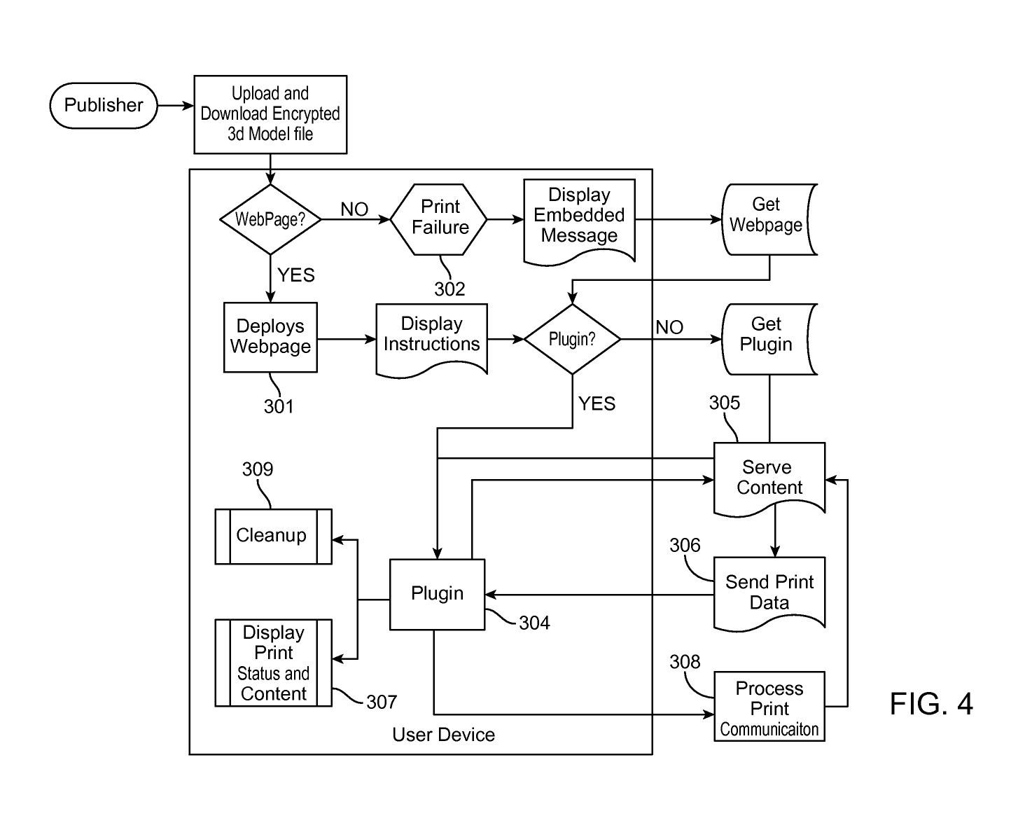

FIG. 4 illustrates a flowchart describing the Printing Process using encrypted 3D Model file, according to a first embodiment. In FIG. 4, the Plugin continuously monitors the printing process and regularly communicates with a Cloud Server for presenting relevant content at a particular stage in the printing process. Moreover, an error message such as print failure (302) might be provided in case there is an error with the printing process. The error message may be embedded within the encrypted 3D Model file and may be presented to the user in various cases such as the WebPage that includes instructions for 3D Printing is not being able to be accessed, or the web browser does not have a Plugin that as discussed above provides the content to be displayed and synchronizes the display of content with the printing process. The Plugin (304) contacts a Cloud Server for providing (305) the content. The Cloud Server provides the print data (306) to the Plugin which in turn provides the instruction to print the 3D Model to the 3D Printer attached to the user device and also provides the content to be presented (307) on the user device. In any aspect, the user device may also be enabled to display (307) the print status of the printing process. In any aspect, the Plugin upon completing the printing process may cleanup (309) all the files downloaded for printing the 3D Model thereby protecting the proprietary 3D Model data from any misuse.

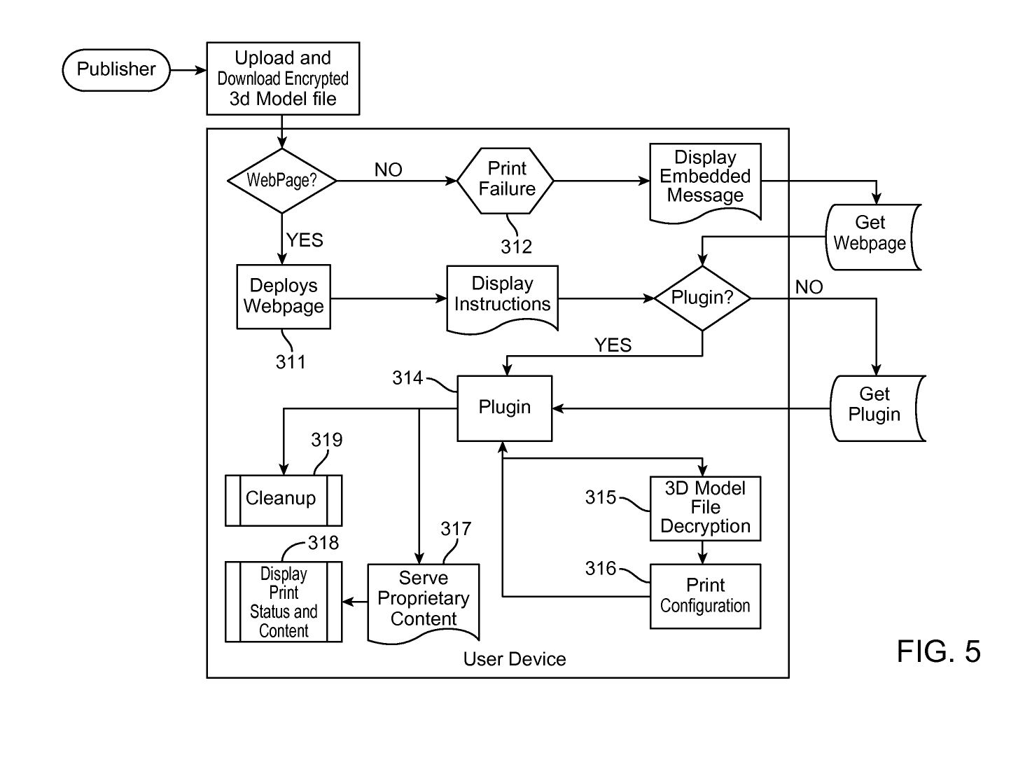

FIG. 5 illustrates a flowchart describing the Printing Process using encrypted 3D Model file, according to a second embodiment. The user device needs to be connected to a network such as the Internet for downloading the WebPage and the Plugin as well as any Plugin updates, if necessary. In case the user device is unable to access the website, an embedded message such as a print failure message (312) is displayed and no printing occurs. Once the user device by means of a web browser accesses the WebPage, a Plugin (314) that is required will be installed in the web browser. This Plugin manages the printing process as well as the presentation of content. In FIG. 5, the content is already embedded during the encryption of the 3D Model files and the Plugin need not contact the Cloud Server for providing the content. During the Plugin's decryption (315) of the 3D Model file, proprietary content (317) is served based on the content that is already embedded during the original compilation of the model files.

The web browser and Plugin are required as well as must be open and running respectively during print time, so that the decryption of 3D Model and serving of the content could be managed. In addition, the method records the click-throughs when user clicks any link from the presented contents to the Cloud Server. Either the .ads file is ran, which installs the Plugin or the WebPage is deployed into the web browser, a Javascript, within the WebPage, checks for the existence of the Plugin and displays the appropriate message to retrieve the Plugin. The Plugin is the Print, Communication and content Serving manager. In case the content Network provides content, the Plugin calls the Cloud Server to evaluate printer environment and, if available, provide preferred Print Configuration settings. In any aspect, the Plugin upon completing the printing process may cleanup (319) all the files downloaded for printing the 3D Model thereby protecting the proprietary 3D Model data from any misuse.

According to the method, the default configuration available for 3D Model as well as the printer is displayed to the user at least prior to the starting of the printing process. Moreover, an error message might be provided in case there is an error with the printing process. Then the Plugin presents Print Configuration details within the web browser where content is being served at this time. The Plugin controls the printer queue and process in order to ensure 3D Model is being decrypted and content presented during print. Plugin manages all delivery of the 3D Model file, printer process and serving the content including digital signature and counter information to the Cloud Server. All files including contents will be buffered in the Plugin. Plugin buffers files so that a temporary loss of Internet connection does not stop the presentation of content or printing. Through the Plugin, the web browser presents the designated content, Print Status and any messages like warning or errors coming from either the printer or Cloud Server. In addition, the Plugin shows completion or failure message with options. Plugin owns the temporary files that are created and is served to the printer, as well as manages the cleanup before the web browser closes. 3D Model file is never left decrypted or whole on user's device.

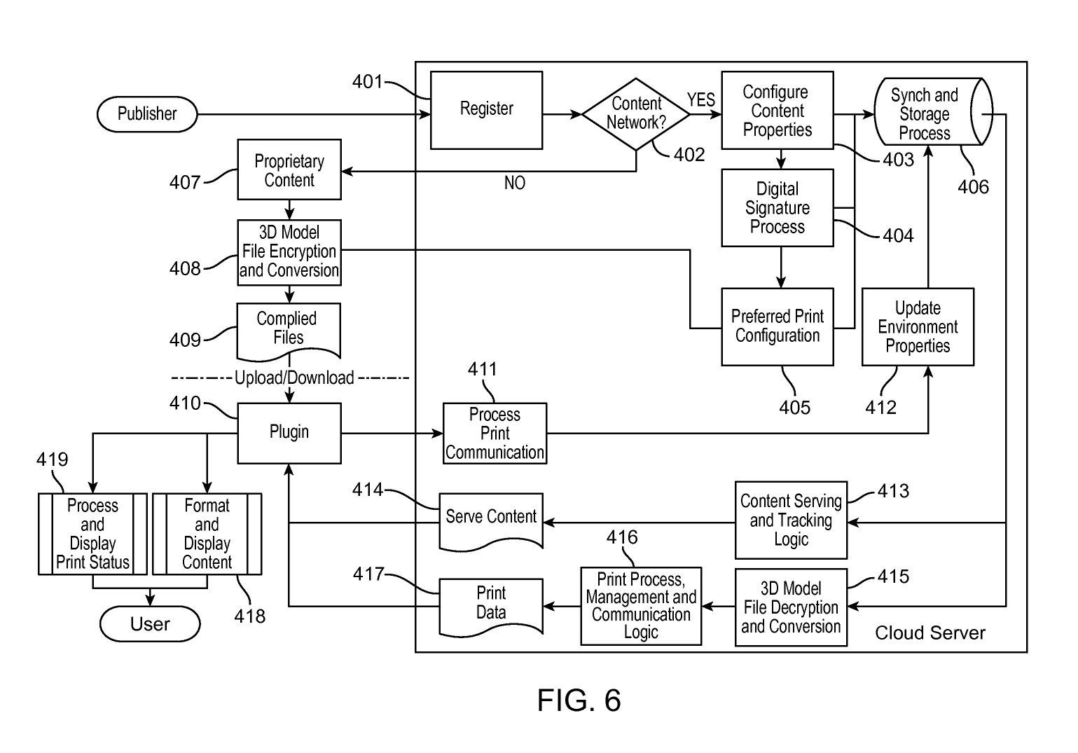

FIG. 6 illustrates a flowchart describing the end-to-end creation and delivery of the 3D Model and content including the interaction between the Publisher and Cloud Server and User and Cloud Server. The Publisher must register (401) and create an account in order to download the software development kit. The Publisher may either be provided an option for embedding proprietary content to be presented or an option for joining a content network (402). Joining the content network may require configuring content properties (403) such as selecting an appropriate category of content to be presented. The content may be provided digital signatures (404) for identifying the owner of the content. The Publisher may also be provided an option for providing preferred print configuration (405).

In the other case, the Publisher may choose embedding the content on his own, in such a case the content, including parameters to serving content and printing parameters, are embedded in the 3D Model files during compile time. Before files are compiled, in one aspect for Proprietary content, the Publisher must include appropriate text and images or media that will display or play during print. No approval or validation is offered or required.

Once the content to be displayed is configured either by means of Proprietary content or by means of content Network the related information and/or files are included in the 3D Model file and the file is encrypted. Such encrypted file is then uploaded on a website along with required instructions or the encrypted file is made available for download by any other means.

Once the user downloads and provides instructions for printing, the Plugin (410) may detect whether the Publisher has embedded the content in the 3D Model files or the content is to be sourced from the content Network having a Cloud Server. The Plugin instructs the 3D Model printer to initiate printing and provides the information (411) regarding the printing process to the Cloud Server. The Cloud Server in turn synchronizes the content to be presented with the printing process (406) and provides (414) the content to be presented along with the details regarding when during the printing process is the content supposed to be presented. In any aspect, the user may not be required to download the 3D Model files on the user device rather the printing related content also is served by the Cloud Server or any other server synced with the content Server residing in the cloud. Prior to printing, the content will be matched with the 3D Model file size and estimated complexity to print (403). Additionally, during printing, content will use user activity to determine the quantity, type and category of content to be served (413).

In order to make a content Network function, each print as well as each content presented must be tracked with a digital signature. Digital signature is a unique identifier that is created and configured during compilation time and takes into account the print machine(s) id(s), Publisher original number (for print), content id (for content presentation), content type, Cloud Server and the like to reliably and exactly identify each and every print and each and every content presented, and it is what is used to make the transaction between the content Producer, content Network, and Publisher possible. All of this data is stored in the Cloud Server. Publishers that join the content Network may be paid for the number of impressions factored by the content Producer, content Network, market conditions, and the like, which is a dynamic real-time process calculated by the content Serving Algorithm.

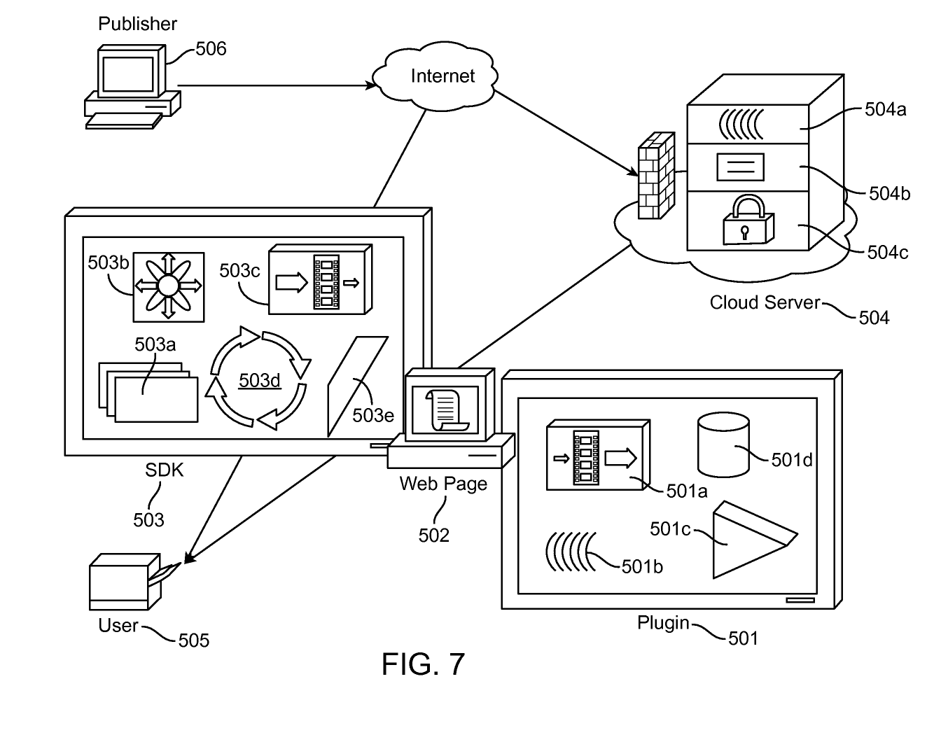

FIG. 7 illustrates a block diagram describing the publisher device, user device, Cloud Server, and the flow of process. The user device (505) is connected to Internet and comprises of an internet browser for browsing a WebPage (502) and the internet browser comprises a web browser Plugin (501) for printing the 3D Model. The user device (505) is communicatively coupled with a 3D Printer and has an output device such as a display device. The web browser Plugin (501) comprises of a 3D Model Decryption Program and Key (501a) for decrypting the encrypted 3D Model files, a Secured Communication Channel (501b) for communicating with the Cloud Server (504), a content Presentation Layer (501c) enabling the presentation of content fetched from the Cloud Server, and 3D Print Drivers (501d) for enabling the 3D Printer to print the model.

The publisher device (506) is connected to Internet and comprises of a Software Development Kit (503). The Software Development Kit (503) comprises of Application Programming Interface (503a), Binary Compiler (503b) for compiling the files, 3D Model Encryption Key and Program (503c) for encrypting the model files, 3D Model file importer and converter (503d), and 3D Model Slicer (503e) for embedding content into the model in various slices.

The Cloud Server (504) may comprise of a plurality of servers such as Messaging Server (504a), content Server (504b), and Account Management Server (504c).

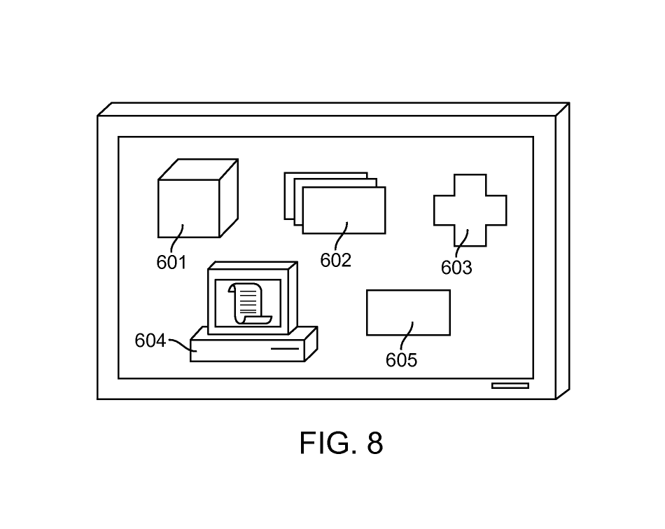

FIG. 8 illustrates a block diagram describing the .ads file or model file and its content. The model file comprises of encrypted 3D Model file (601), Scripts (602) wherein one script may be included for each operating system being supported for printing, Plugin (603) wherein one Plugin may be included for each web browser being supported, WebPage (604), and Instructional Text (605). The .ads file is a Program that essentially contains the encrypted 3D Model file(s), WebPage, Plugin, Scripts and Instructional Text. When the .ads file is double clicked, it will install or run just as a Program would on given operating system using the contained Scripts. The Program will deploy on the default web browser the WebPage. The .ads file format is solely managed by the software development kit (503) and only allows controlled manipulation of the 3D Model in addition to the content Serving System to eliminate malicious attacks or nefarious attempts to take advantage of the Public. However, if .ads file is not transferable or accepted: the encrypted 3D Model file could be shared with the separate instructional text (605), WebPage (604) or link to the WebPage (702) served by the Cloud Server. Besides the instructions, the instructional text provides a link for the WebPage available online (605). If WebPage is not opened first, trying to print the 3D Model will cause an error (302,312) and the custom embedded content including error message (702), which displays a link to the WebPage available online. Unless the user already has the Plugin, the WebPage must be opened first.

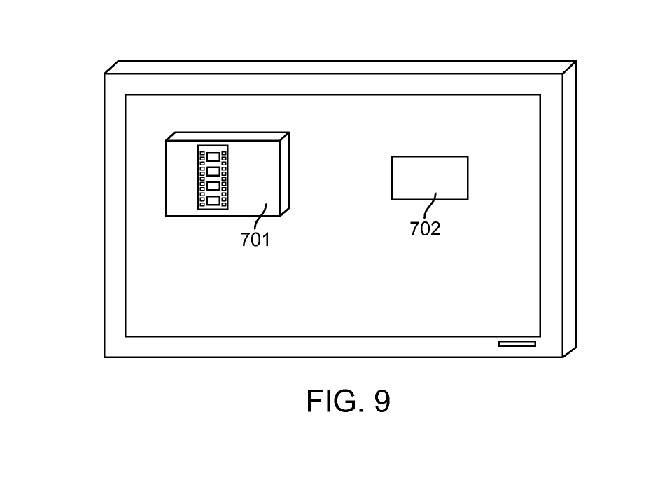

FIG. 9 illustrates a block diagram describing the encrypted 3D Model and its content after compilation. The model contains an encrypted 3D Model file (701) and embedded content including the error message (702).

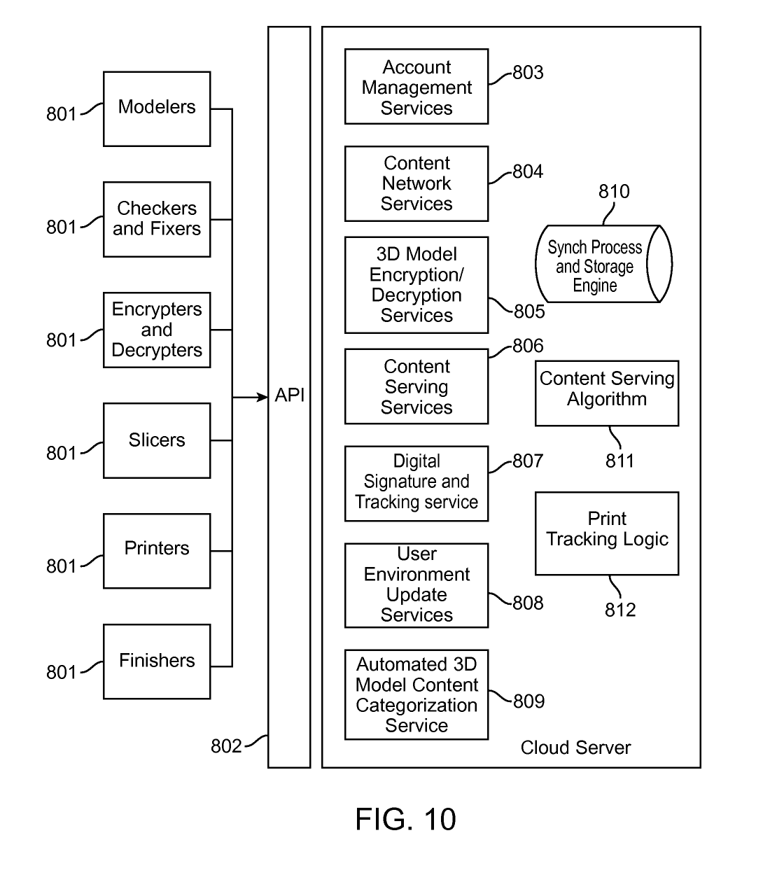

FIG. 10 illustrates a block diagram describing the Application Programming Interface and print phases availability. The Cloud Server API is available for various Providers to access Cloud Server services to do activities, such as auto-connect with the content Network for Printer Makers, so that print drivers can ensure content being served and presented, is native in printing and in the process by default. API could be used at any point within the 3D Model development and Print lifecycle (802), and by any Provider through various methods such as in the 3D Modeling software, standalone custom application running directly on the operating system, custom web browser extension, in 3D Model slicers and file converters, and in the print driver itself (801).

The Account Management Services (803) include Account Management for Publishers for all areas of the published 3D Model files and content Network participation information; if applicable, Account Management for content Network Producers including all areas of content Network participation information; Account Management for 3rd Party Suppliers using the API content Network Services (804). All services related to creating, editing, managing, and removing contents and their associations to 3D Model files.

The 3D Model Encryption and Decryption Service (805) includes Services responsible for producing through compilation a whole and viable binary that is protected and then released for printing. This is the same service offered by the software development kit, except it is performed on the Cloud Server, not the Publisher's local machine. The software development kit may contact and use the Cloud Server for certain advanced options.

The content Serving Services (806) include services responsible for the request and delivery of contents for all supported content formats based on content Network properties and conditions taking into consideration the user environment, Digital Signature and content Presentation Tracking Services, Services that creates and tracks all transactions that when coupled with the 3D Model, Encryption and Decryption Services ensures a print of a 3D Model file presents appropriate content the appropriate number of times.

The Digital Signature and Tracking Services (807) include all services that produce a digital signature or unique identifier for all 3D Models and for each print of that 3D Model. The tracking services handles all of the registering, calculating and grouping of the prints on the 3D Models so that it may be recorded with the contents that are served at the time of print of the 3D Model.

The User Environment Updates Services (808) includes services that receives and process user environment data such as web browser type and version, operating system, system resources, printer type, and the like, so that decisions such as what is the correct print configuration, what type of contents to serve, when to pause printing due to violations like closing the browser and the like are made.

The Automated 3D Model content Categorization Services (809) includes services responsible for taking properties and attributes from the 3D Model to assess which content category it should be added to as well as what type of geography or demographic would print such a file. This is optionally for Publishers even if content categories are configured prior to compilation time, which will aide in the accuracy of the content targeting.

The Synchronization Process and Storage Engine (810) houses all the supported print drivers, 3D Modelling file converters, web browser types for Plugins, supported operating system interfaces, account information, contents, etc. that the Cloud Server needs to function as the repository for the content Serving System and Delivery Scheme for 3D Model files.

The content Serving Algorithm (811) process all the content and 3D Model linking, forecasting, geographic, demographic and behavioral information needed to have accurate content targeting. In addition, manages the content auction information and payment and credit information to provide a reliable exchange—essentially the brain of the content Network.

The Print Tracking Logic (812) includes all decision logic to ensure the 3D Model file throughout its lifecycle prints properly for various consumers and printer types. The logic is intelligent enough to decide ideal conditions and settings as well as appropriate file format conversion logic needed to print the 3D Model and the like.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Embodiments of the present invention may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the computer-readable medium or by copying the code from the computer-readable medium into another computer-readable medium (e.g., a hard disk, RAM, etc.) or by transmitting the code on a network for remote execution. Various methods described herein may be practiced by combining one or more computer-readable media containing the code according to the present invention with appropriate standard computer hardware to execute the code contained therein. An apparatus for practicing various embodiments of the present invention may involve one or more computers (or one or more processors within a single computer, or one or more processor cores) and storage systems containing or having network access to computer program(s) coded in accordance with various methods described herein, and the method steps of the invention could be accomplished by modules, routines, subroutines, or subparts of a computer program product.

While for purposes of simplicity of explanation, the illustrated methodologies are shown and described as a series of blocks/steps, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied there from beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

Moreover, although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A system for serving content during a printing process of a 3D Model, the system comprises of:
a user device having a web browser with a Plugin and communicatively connected to a Cloud Server and a 3D Printer;
the Cloud Server being configured for storing information related to the 3D Model;
the 3D Printer being configured for receiving instructions from the user device for printing the 3D Model; wherein
the user device is configured for browsing a website having information and one or more executable files related to the 3D Model;
the user device is configured for downloading the one or more files and executing the downloaded files and instructing the 3D Printer for printing the 3D Model; and
the Plugin being configured for monitoring the printing process and in conjunction with the Cloud Server being configured for serving the content to the user device after synchronizing the printing process and the logistics of serving content.

2. The system as claimed in claim 1, wherein the user device is connected to the Cloud Server by means of Internet.

3. The system as claimed in claim 1, wherein the content is embedded in the 3D Model files during the compilation of the 3D Model files.

4. The system as claimed in claim 1, wherein the content is stored in the Cloud Server.

5. The system as claimed in claim 1, wherein the downloaded files include an encrypted original CAD file.

6. The system as claimed in claim 1, wherein the downloaded files include a .ads file.

7. The system as claimed in claim 1, wherein the Plugin provides printing related information to the Cloud Server for synchronizing the printing process with the serving of the content.

8. The system as claimed in claim 7, wherein serving of the content comprises of fetching the content from the Cloud Server based on the status of the printing process and presenting the fetched content on the user device.

9. The system as claimed in claim 1, wherein the content format is selected from the group consisting of like text format, image format, text with image format, audio format and video with audio format.

10. A method for serving content during a printing process of a 3D Model, the method comprising process implemented steps of:
browsing a website having information and one or more files related to the 3D Model;
downloading the one or more files and executing the downloaded files and instructing a 3D Printer for printing the 3D Model;
monitoring the printing process by a Plugin and in conjunction with a Cloud Server serving the content to a user device after synchronizing the printing process and the logistics of serving content.

11. The method as claimed in claim 10, wherein the content is embedded in the 3D Model files during the compilation of the 3D Model files.

12. The method as claimed in claim 10, wherein the content is stored in the Cloud Server.

13. The method as claimed in claim 10, wherein the downloaded files include an encrypted original CAD file.

14. The method as claimed in claim 10, wherein the downloaded files include a .ads file.

15. The method as claimed in claim 10, wherein the Plugin provides printing related information to the Cloud Server for synchronizing the printing process with the serving of the content.

16. The method as claimed in claim 15, wherein the step of serving of the content comprises of fetching the content from the Cloud Server based on the status of the printing process and presenting the fetched content on the user device.

17. The method as claimed in claim 10, wherein the content format is selected from the group consisting of like text format, image format, text with image format, audio format and video with audio format.
